(19) United States
(12) Patent Application Publication
(10) Pub. No.: US 2015/0095087 A1
(43) Pub. Date: Apr. 2, 2015

(54) Calendar Integration In A Collaborative Environment

(71) Applicant: International Business Machines Corporation, Armonk, NY (US)

(72) Inventors: Darryl M. Adderly, Morrisville, NC (US); Michelle Davis, Raleigh, NC (US)

(73) Assignee: International Business Machines Corporation, Armonk, NY (US)

(21) Appl. No.: 14/040,833

(22) Filed: Sep. 30, 2013

(51) Int. Cl. G06Q 10/10

(52) U.S. Cl. CPC G06Q 10/1095
USPC 705/7.19

(57) ABSTRACT

Integration of a virtual collaborative environment with an electronic meeting calendar. The virtual collaborative environment functions in a shared pool of resources to provide a virtual medium for multiple entities to work together. The electronic meeting calendar and scheduling integrates with the collaboration. Three separate and distinct factors are accounted for with the scheduling, including establishing a meeting, the duration of the meeting, and the attendees. Each of these factors is considered based upon content uploaded to the collaborative environment.

### BACKGROUND

1. Technical Field

The present invention relates generally to collaboration through an electronic medium. More specifically, the invention relates to leveraging the collaboration to support scheduling of an electronic meeting and communication of the scheduled meeting to intended participants.

2. Background

Electronic collaboration and scheduling generally take place in two disparate and unrelated aspects. One aspect pertains to collaboration, and another aspect pertains to management and maintenance of a calendar schedule. Currently, these two aspects operate in a parallel or near parallel relationship, but do not cross paths for functionality. More specifically, activity in the collaboration environment does not connect with the calendar, thereby requiring separate applications to schedule meetings regarding content shared in the collaborative environment.

### SUMMARY OF THE INVENTION

This invention comprises a method, system, and computer program product for automated meeting scheduling in a virtual collaborative environment.

In one aspect, a method is provided for saving new content to an electronic collaborative environment and automated scheduling of a meeting with variable meeting parameters dependent on the saved content. The new content is assessed with respect to prior content saved within the collaborative environment. If the comparison of the new content with the prior content exceeds a threshold, a meeting is automatically proposed. The meeting includes both a subject of the meeting and list of attendee email addresses directly related to the new content. An electronic meeting invitation is generated and pre-filled for the meeting, with the invitation including details for the meeting based on the subject of the meeting and the list of attendee email addresses. Once the invitation is generated, it is sent to each of the attendees via each associated electronic mail address.

In another aspect, a system is provided with a computing node in communication with a server node. The computing node includes a processing unit in communication with memory. The computing node is in communication with a server node across a network connection, with the server node having a processing unit in communication with memory. The server node includes tools to support meeting scheduling in a virtual collaborative environment in response to receipt of new content. An assessment manager, comparison manager, and invitation manager are provided to support the evaluation of the content for meeting scheduling and invitation processing. The assessment manager evaluates the new content with respect to prior content saved within the collaborative environment. The comparison manager compares the new content with the prior content, and based upon whether the comparison exceeds a threshold, the comparison manager automatically proposes a meeting, with both a subject of a meeting and list of attendee email addresses directly related to the new content. The invitation manager pre-fills an electronic meeting invitation for the meeting with details for the electronic meeting invitation based on the subject of the meeting and the list of attendee email addresses. Furthermore, the invitation manager sends an electronic meeting invitation for the meeting to each of the attendees via each associated electronic mail address.

In yet another embodiment, a computer program product delivered as a service through a network connection is provided. The computer program product includes a computer readable storage device in communication with a processing unit. The storage device has computer readable program code embodied therewith. The code is configured to save new content within an electronic collaborative environment, evaluate the new content with respect to prior content saved to the collaborative environment, and based upon whether a comparison of the new content with the prior content exceeds a threshold, the code automatically proposes a meeting. Both a subject of the meeting and list of attendee email addresses directly related to the new content is included with the proposed meeting. In addition, the code pre-fills an electronic meeting invitation for the meeting. The invitation includes details for the electronic meeting invitation based on the subject of the meeting and the list of attendee email addresses. Once completed, the code sends the electronic meeting invitation for the meeting to each of the attendees via each associated electronic mail address.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts a flow chart illustrating a process for automation of a process for scheduling a meeting in a virtual collaborative environment.

FIG. 5 depicts a flow chart illustrating a process for evaluating content present on the portal and comparison of the content being evaluated to prior portal content.

FIG. 6 depicts a block diagram showing a system for automation of meeting scheduling in a collaborative environment.

FIG. 7 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of managers, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

Collaboration with one or more individuals or groups requires scheduling meetings or common time intervals for work on a project; collaboration takes place non-virtually or virtually. Regardless of the format of the collaboration environment, it is understood that individuals or groups involved in the collaboration gather in a location to communicate and/or exchange information, ideas, knowledge, etc. Scheduling a time for meeting at a location may be triggered by different events. In a virtual environment, such events include, but are not limited to, completion of entering content on a secured virtual location, the amount of modifications to the content, etc. Scheduling the meeting time and location is automated in response to a triggering event. Criteria to determine when to recommend a meeting is based on the content type, including but not limited to, quantity of characters, lines of text, quantity of cells, etc. Accordingly, there are physical or virtual criteria that initiate scheduling of the meeting.

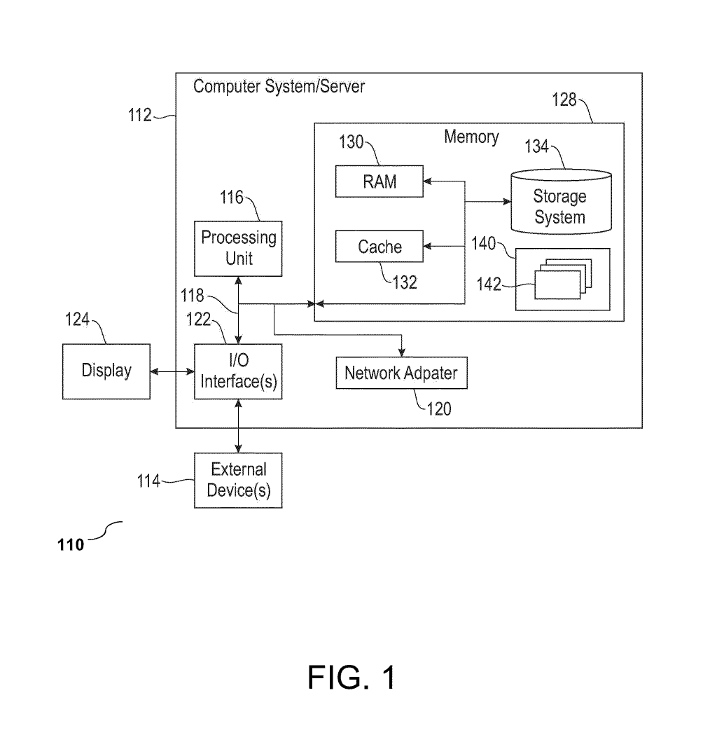

In one embodiment, the collaborative environment takes placed in a cloud computing environment. A cloud computing environment is service oriented with a focus on statelessness, low coupling, modularity, and semantic interoperability. At the heart of cloud computing is an infrastructure comprising a network of interconnected nodes. Referring now to FIG. 1, a schematic of an example of a cloud computing node is shown. Cloud computing node (110) is only one example of a suitable cloud computing node and is not intended to suggest any limitation as to the scope of use or functionality of embodiments of the invention described herein. Regardless, cloud computing node (110) is capable of being implemented and/or performing any of the functionality set forth hereinabove. In cloud computing node (110) there is a computer system/server (112), which is operational with numerous other general purpose or special purpose computing system environments or configurations. Examples of well-known computing systems, environments, and/or configurations that may be suitable for use with computer system/server (112) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (112) may be described in the general context of computer system-executable instructions, such as program modules, being executed by a computer system. Generally, program modules may include routines, programs, objects, components, logic, data structures, and so on that perform particular tasks or implement particular abstract data types. Computer system/server (112) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server (112) in cloud computing node (110) is shown in the form of a general-purpose computing device. The components of computer system/server (112) may include, but are not limited to, one or more processors or processing units (116), a system memory (128), and a bus (118) that couples various system components including system memory (128) to processor (116). Bus (118) represents one or more of any of several types of bus structures, including a memory bus or memory controller, a peripheral bus, an accelerated graphics port, and a processor or local bus using any of a variety of bus architectures. By way of example, and not limitation, such architectures include an Industry Standard Architecture (ISA) bus, a Micro Channel Architecture (MCA) bus, an Enhanced ISA (EISA) bus, Video Electronics Standards Association (VESA) local bus, and a Peripheral Component Interconnects (PCI) bus. A computer system/server (112) typically includes a variety of computer system readable media. Such media may be any available media that is accessible by a computer system/server (112), and it includes both volatile and non-volatile media, and removable and non-removable media.

System memory (128) can include computer system readable media in the form of volatile memory, such as random access memory (RAM) (130) and/or cache memory (132). Computer system/server (112) may further include other removable/non-removable, volatile/non-volatile computer system storage media. By way of example only, storage system (134) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (118) by one or more data media interfaces. As will be further depicted and described below, memory (128) may include at least one program product having a set (e.g., at least one) of program modules that are configured to carry out the functions of embodiments of the invention.

Program/utility (140), having a set (at least one) of program modules (142), may be stored in memory (128) by way of example, and not limitation, as well as an operating system, one or more application programs, other program modules, and program data. Each of the operating systems, one or more application programs, other program modules, and program data or some combination thereof, may include an implementation of a networking environment. Program modules (142) generally carry out the functions and/or methodologies of embodiments of the invention as described herein.

Computer system/server (112) may also communicate with one or more external devices (114), such as a keyboard, a pointing device, a display (124), etc.; one or more devices that enable a user to interact with computer system/server (112); and/or any devices (e.g., network card, modem, etc.) that enable computer system/server (112) to communicate with one or more other computing devices. Such communication can occur via Input/Output (I/O) interfaces (122). Still yet, computer system/server (112) can communicate with one or more networks such as a local area network (LAN), a general wide area network (WAN), and/or a public network (e.g., the Internet) via network adapter (120). As depicted, network adapter (120) communicates with the other components of computer system/server (112) via bus (118). It should be understood that although not shown, other hardware and/or software components could be used in conjunction with computer system/server (112). Examples, include, but are not limited to: microcode, device drivers, redundant processing units, external disk drive arrays, RAID systems, tape drives, and data archival storage systems, etc.

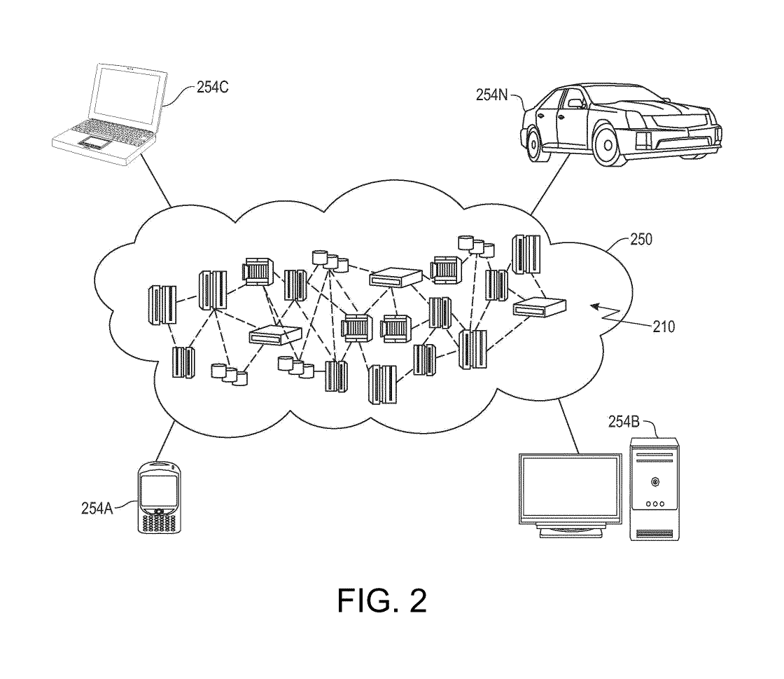

Referring now to FIG. 2, illustrative cloud computing environment (250) is depicted. As shown, cloud computing environment (250) comprises one or more cloud computing nodes (210) with which local computing devices used by cloud consumers, such as, for example, personal digital assistant (PDA) or cellular telephone (254A), desktop computer (254B), laptop computer (254C), and/or automobile computer system (254N) may communicate. Nodes (210) may communicate with one another. They may be grouped (not shown) physically or virtually, in one or more networks, such as Private, Community, Public, or Hybrid clouds as described hereinabove, or a combination thereof. This allows cloud computing environment (250) to offer infrastructure, platforms and/or software as services for which a cloud consumer does not need to maintain resources on a local computing device. It is understood that the types of computing devices (254A)-(254N) shown in FIG. 2 are intended to be illustrative only and that computing nodes (210) and cloud computing environment (250) can communicate with any type of computerized device over any type of network and/or network addressable connection (e.g., using a web browser).

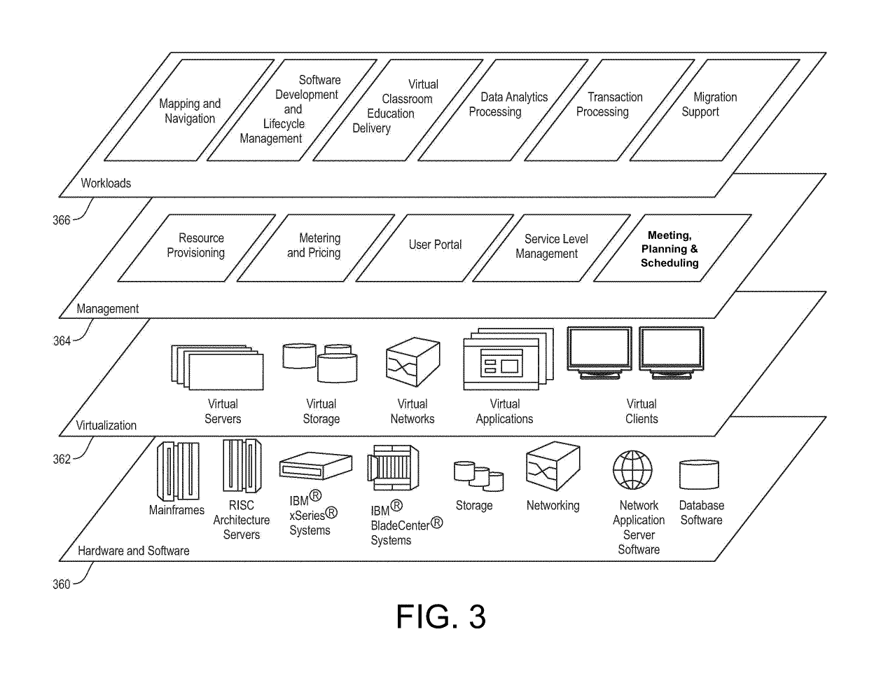

Referring now to FIG. 3, a set of functional abstraction layers provided by cloud computing environment (250) is shown. It should be understood in advance that the components, layers, and functions shown in FIG. 3 are intended to be illustrative only and embodiments of the invention are not limited thereto. As depicted, the following layers and corresponding functions are provided: hardware and software layer (360), virtualization layer (362), management layer (364), and workload layer (366). The hardware and software layer (360) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (362) provides an abstraction layer from which the following examples of virtual entities may be provided: virtual servers; virtual storage; virtual networks, including virtual private networks; virtual applications and operating systems; and virtual clients.

In one example, management layer (364) may provide the following functions: resource provisioning, metering and pricing, user portal, service level management, and meeting planning and scheduling. The functions are described below. Resource provisioning provides dynamic procurement of computing resources and other resources that are utilized to perform tasks within the cloud computing environment. Metering and pricing provides cost tracking as resources that are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Meeting planning and scheduling enhance virtual communication among a plurality of collaborators in the cloud computing environment.

Workloads layer (366) provides examples of functionality for which the cloud computing environment may be utilized. An example of workloads and functions which may be provided from this layer includes, but is not limited to, organization and management of data objects within the cloud computing environment. In the shared pool of configurable computer resources described herein, hereinafter referred to as a cloud computing environment, files may be shared among users within multiple data centers, also referred to herein as data sites. A series of mechanisms are provided within the shared pool to provide organization and management of data storage.

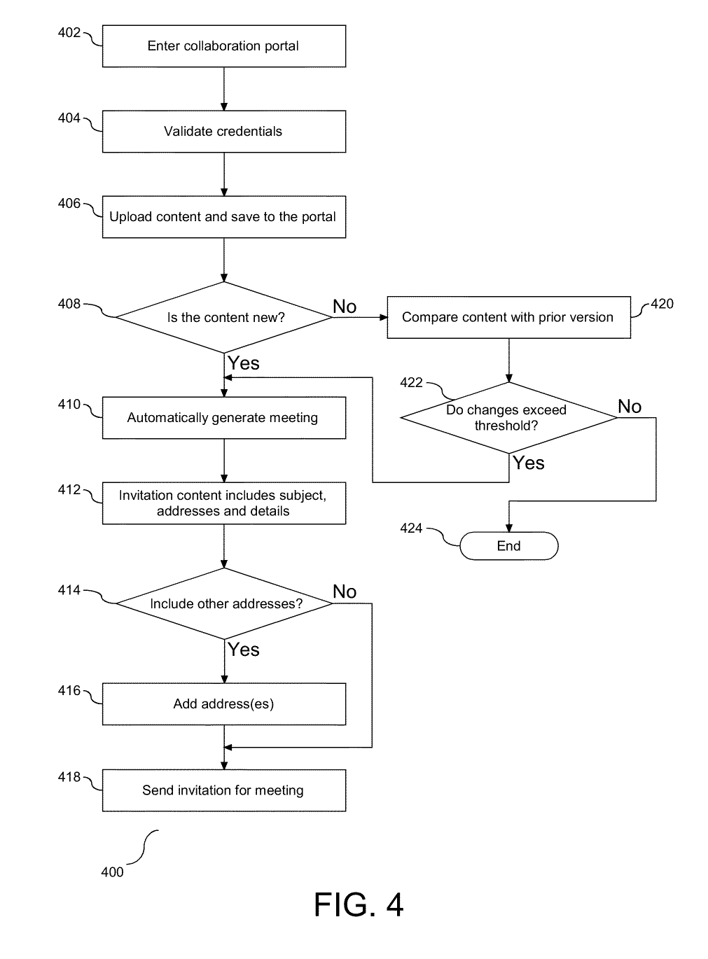

FIG. 4 is a flow chart (400) illustrating a process for automation of a process for scheduling a meeting in a virtual collaborative environment, such as a cloud based shared resource computing environment. As shown, the collaborative environment is entered (402), and credentials for the entity that entered the environment are validated (404). In one embodiment, the environment may be a social media platform. Once the validation is completed and approved, the entity may submit and save content to the portal (406), including uploading new content, updating a file, etc. It is then determined if the content that has been submitted to the portal is new content (408). Scheduling a meeting is based in part on characteristics of the uploaded content. If at step (408) it is determined that the submitted content is new, e.g. contains matter not previously saved in the portal, then a meeting may be automatically generated (410). In one embodiment, the new content does not necessitate scheduling a meeting.

Once a meeting is generated, a calendar meeting invitation is created with content pertaining to the meeting (412). The detail may include, but are not limited to subject matter, electronic addresses, and details. In a collaborative environment, the focus is to include members involved in the material being collaborated. Following creation of the invitation, it is determined if other electronic addresses should be included with the invitation (414), i.e. should any other entities or persons be invited to the meeting. If the response to the determination at step (414) is positive, addresses for those entities are added (416) and an calendar meeting invitation is sent to the added addresses (418). Accordingly, in a virtual collaborative environment, invitations are communicated electronically to addresses with members and/or entities involved in the collaboration and to any additional entities for that it is determined should be present at the meeting.

As shown at step (408), a determination is conducted to assess the content added to the collaborative portal to determine if a threshold for conducting a meeting has been met. If the response to the determination at step (408) is negative, the content that has been uploaded and saved to the portal is compared with one or more prior versions of the content (420). It is then determined if the changes associated with the uploaded and saved content exceed a threshold (422). In one embodiment, the assessment at step (422) provides a second look at the content to determine if a meeting should be scheduled. A positive response to the assessment at step (422) is followed by a return to step (410) for generating a meeting. Alternatively, a negative response to the assessment at step (422) concludes the evaluation of uploaded content to the collaborative venue without generating a meeting (424). Accordingly, uploaded content to the collaborative site is evaluated on characteristics of the content, and under limited conditions a meeting is automatically generated.

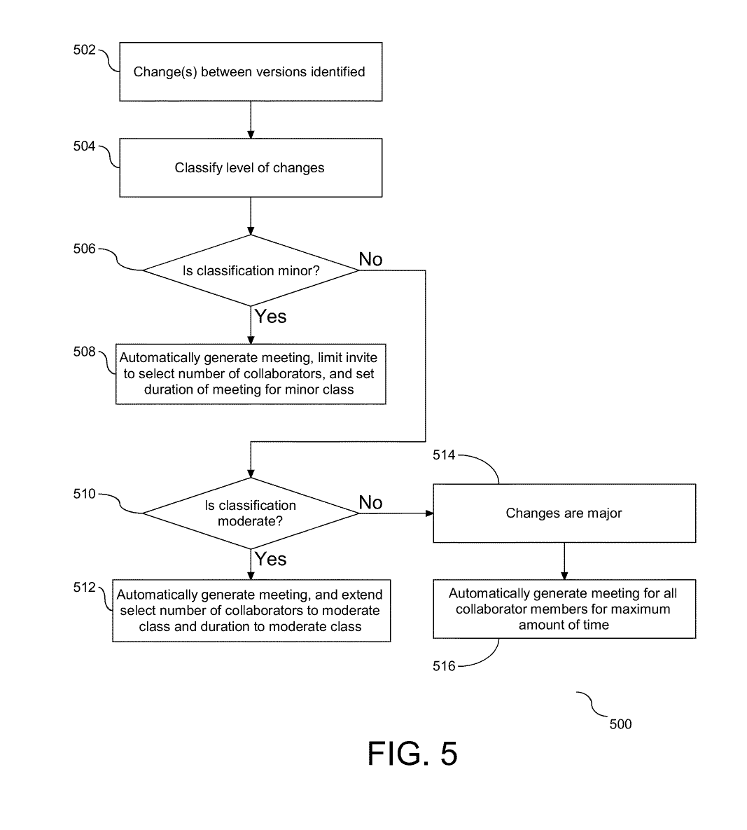

As shown in FIG. 4, the uploaded content may be new content in one of two forms. For example, the new content may pertain to subject matter being collaborated, or the new content may be based on a quantity of content uploaded and related to subject matter of previously uploaded content. FIG. 5 is a flow chart (500) illustrating a process for evaluating content present on the portal and comparison of the content being evaluated to prior portal content. A change between content of the uploaded data to the previously saved portal data is identified (502), and levels of the changes are classified (504). In one embodiment, the classification is based on the quantity of changes that is apparent from the comparison. The order of the classification assessments shown and described below is not limiting, and in one embodiment may be in a different order. For descriptive purposes, there are three classes of changes identified, including minor, moderate, and major. However, in one embodiment, the quantity of classes associated with identified changes may vary, including both a greater quantity and a lesser quantity of classes. Accordingly, the classes described below are associated with changes identified between versions of content uploaded to a collaborative environment.

In the illustration shown herein, the initial determination is whether the classification is minor (506). A minor classification is a minimum threshold for classification of changes. If the classification is minor, a meeting is automatically generated with parameters designated for the classification (508). Specifically, the meeting invitation is limited to a select number of collaborators and the duration of the meeting is limited, e.g. set for a minor class. If at step (506), the classified level of changes in the content is not considered minor, the content change is assessed to determine if the quantity of changes classifies as moderate (510). A moderate classification is an intermediate threshold for classification of changes. If the classification is moderate, a meeting is automatically generated with parameters designated for the classification (512). Specifically, the meeting invitation is extended in comparison to the minor classification level, with the quantity of attendees extended to a select number of collaborators, and as the same time the duration of the meeting is extended to the time set for the moderate classification. If at step (506), the classified level of changes in the content is not considered minor and at step (510) the classified level of changes in the content is not considered moderate, then in a classification with only three tiers, the identified quantity of changes are assigned a major classification level (514). A meeting is automatically generated for all collaborator members associated with the uploaded content, and at the same time the meeting duration is set for a maximum amount of time set for the major classification. Accordingly, a hierarchical classification system is established and correlated with the quantity of changes identified between versions of content uploaded to the collaborative site and a meeting invitation is automatically generated with duration and collaborators assigned based on the classification of the identified changes.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer or mobile device (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

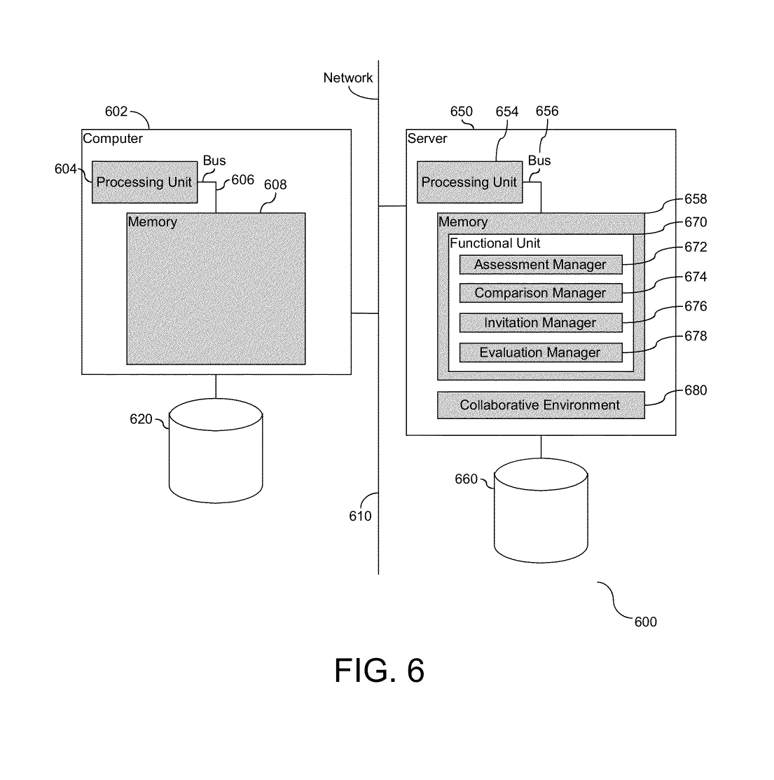

FIG. 6 illustrates a system (600) for automation of meeting scheduling in a virtual collaborative environment. A computer or related computing device (602) is provided in communication with data storage (620). The computer or related device (602) includes a processing unit (604) in communication with memory (608) across a bus (606). The computer or related device (602) is in communication with a server (650) across a network connection (610). In one embodiment, the server (650) may be a part of a remote data center. While only one server (650) and one computer node (602) are depicted, any number of servers and computer nodes may be implemented. The server (650) includes a processing unit (654) in communication with memory (658) across a bus (656). At the same time, the server (650) is in communication with data storage (660). A functional unit (670) is provided embedded in memory (658), and includes tools to support functionality associated with the collaborative environment. The tools include, but are not limited to, an assessment manager (672), a comparison manager (674), an invitation manager (676), and an evaluation manager (678). Together the managers (672)-(678) function to provided automated meeting scheduling in the collaborative environment.

As indicated above, the computer node or related device (602), such as a mobile computing device, is in communication with the server (650) across the network connection (610). In one embodiment, there are multiple computers nodes that communicate with the server, with the communication including content uploaded and storage on data storage (660). The server (650) provides a venue in which data may be uploaded from multiple computer or related device nodes (602) and shared in a collaborative environment (680). In one embodiment, the server (650) enables and facilitates the collaboration by maintaining a communication conduit into the collaborative environment (680). As new content is uploaded and saved to the collaborative environment (680), the assessment manager (672) evaluates the content. In one embodiment, the evaluation includes determining if the content is related to any prior content in the environment. The content may be new content, in which it is not related to any prior content in the collaborative environment (680). In one embodiment, new content may be associated with a new project and not related to any prior content. Similarly, in one embodiment, new content may be associated with an established project, and related to prior content within the environment.

Based on the assessment, the comparison manager (674) compares the new content with any prior content in the collaborative environment (680). More specifically, if there is prior related content, the comparison manager (674) assesses whether the quantity of changes between the new content and the prior content exceeds a threshold. For any uploaded file and/or content that exceeds the threshold, the comparison manager (674) automatically proposes a meeting to a select set of members of the collaborative environment. In one embodiment, the collaborative environment is a venue in which membership is limited. The proposed meeting includes both a subject of the meeting and an electronic communication addresses for each attendee being invited to the meeting, with each attendee directly related to the new uploaded content.

Based on the proposed meeting, the invitation manager (676) created an electronic meeting invitation. In one embodiment, the invitation includes one or more fields associated with general characteristics of a meeting. The invitation manager (676) pre-fills the fields with details for the meeting; the details include, but are not limited to, the subject matter of the meeting and a list of attendees who are invited and/or required to participate in the meeting. Once the invitation is completed, the invitation manager (676) sends the electronic meeting invitation to each of the attendees, as reflected by their respective electronic mail addresses. Accordingly, in a virtual collaborative environment, an electronic meeting invitation is created and sent to members of the collaborative environment that are related to the subject matter of the uploaded content.

The collaborative environment may include a limited quantity of members. In one embodiment, the members are individuals who comprise a team for a project. Different members may have different roles in the project. Based upon their respective roles, the uploaded content may or may not be relevant, and as such, the uploaded content should be evaluated to determine the relevance of the content to the role of each of the members of the collaborative environment. This evaluation provides efficiency in use of time for members. The evaluation manager (678) functions to evaluate the uploaded content. More specifically, the evaluation manager (678) evaluates the type of data associated with the uploaded content and selectively schedules the meeting based upon the evaluated data type. As noted above, the comparison manager (674) serves a different role than the evaluation manager (678). The comparison manager (674) provides a measurement, and the evaluation manager (678) acts on the comparison. More specifically, the comparison manager (674) measures and identifies a quantity of changes, and then provides a classification of changes in content based on the quantity.

As elaborated in detail in FIG. 5, changes may be classified based on a hierarchy of defined tiers. In one embodiment, the tiers include minor, moderate, and major, although such classification of the tiers are not considered limiting. The evaluation of the content by the assessment manager (672) includes appraising the quantity of content changes. For example, if the quantity of changes is appraised as minor, then the assessment manager (672) limits the attendees for the virtual meeting invitation to a select set of collaborators and also limits the duration of the meeting to a minimum time interval. If the quantity of changes is appraised as moderate, then the assessment manager (672) extends the attendees to a moderate class of collaborators, which in one embodiment, is larger than the select set of collaborators associated with the minor classification but less than all of the collaborators. In addition, the assessment manager (672) sets the duration of the meeting to a moderate class time interval, which in one embodiment is a greater time interval than the limited duration associated with the minor classification. If the quantity of changes is appraised as major, then the assessment manager (672) extends the attendees for the virtual meeting invitation to all of the collaborators associated with the uploaded content. In addition, the assessment manager (672) sets the duration of the meeting to a maximum amount of time provided. Accordingly, the assessment manager (672) controls the attendees and duration of the virtual meeting.

The described features, structures, or characteristics may be combined in any suitable manner in one or more embodiments. Examples of the managers have been provided to lend a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The functional unit described above in FIG. 6 has been labeled with managers. The managers may be implemented in programmable hardware devices such as field programmable gate arrays, programmable array logic, programmable logic devices, or the like. The manager(s) may also be implemented in software for processing by various types of processors. An identified manager of executable code may, for instance, comprise one or more physical or logical blocks of computer instructions which may, for instance, be organized as an object, procedure, function, or other construct. Nevertheless, the executable of an identified manager need not be physically located together, but may comprise disparate instructions stored in different locations which, when joined logically together, comprise the managers and achieve the stated purpose of the managers.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

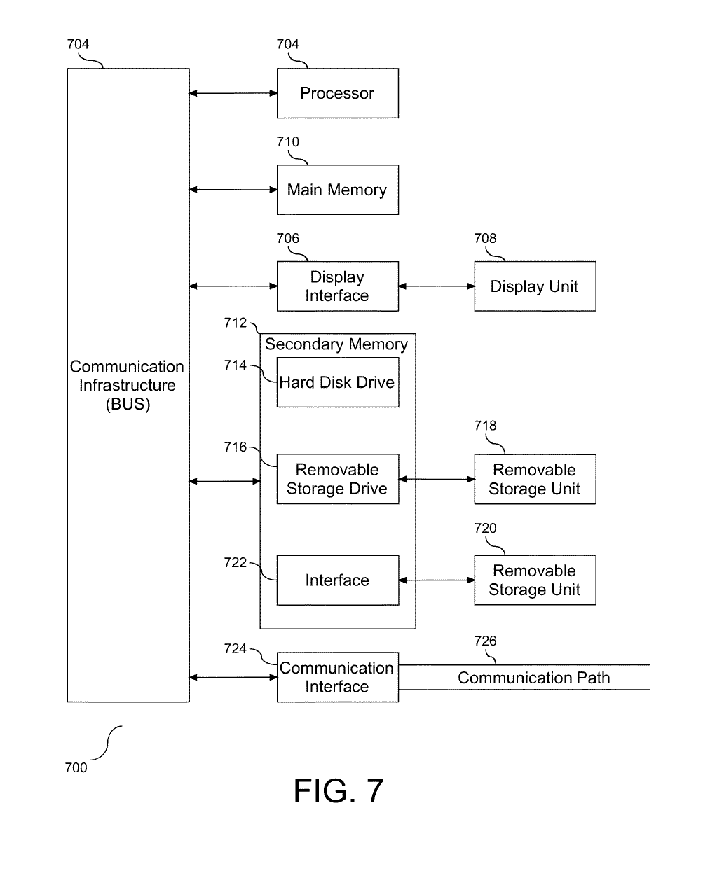

Referring now to the block diagram (700) of FIG. 7, additional details are now described with respect to implementing an embodiment of the present invention. The computer system includes one or more processors, such as a processor (702). The processor (702) is connected to a communication infrastructure (704) (e.g., a communications bus, cross-over bar, or network).

The computer system can include a display interface (706) that forwards graphics, text, and other data from the communication infrastructure (704) (or from a frame buffer not shown) for display on a display unit (708). The computer system also includes a main memory (710), preferably random access memory (RAM), and may also include a secondary memory (712). The secondary memory (712) may include, for example, a hard disk drive (714) (or alternative persistent storage device) and/or a removable storage drive (716), representing, for example, a floppy disk drive, a magnetic tape drive, or an optical disk drive. The removable storage drive (716) reads from and/or writes to a removable storage unit (718) in a manner well known to those having ordinary skill in the art. Removable storage unit (718) represents, for example, a floppy disk, a compact disc, a magnetic tape, or an optical disk, etc., which is read by and written to by a removable storage drive (716). As will be appreciated, the removable storage unit (718) includes a computer readable medium having stored therein computer software and/or data.

In alternative embodiments, the secondary memory (712) may include other similar means for allowing computer programs or other instructions to be loaded into the computer system. Such means may include, for example, a removable storage unit (720) and an interface (722). Examples of such means may include a program package and package interface (such as that found in video game devices), a removable memory chip (such as an EPROM, or PROM) and associated socket, and other removable storage units (720) and interfaces (722) which allow software and data to be transferred from the removable storage unit (720) to the computer system.

The computer system may also include a communications interface (724). Communications interface (724) allows software and data to be transferred between the computer system and external devices. Examples of communications interface (724) may include a modem, a network interface (such as an Ethernet card), a communications port, or a PCMCIA slot and card, etc. Software and data transferred via communications interface (724) are in the form of signals which may be, for example, electronic, electromagnetic, optical, or other signals capable of being received by communications interface (724). These signals are provided to communications interface (724) via a communications path (i.e., channel) (726). This communications path (726) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (710) and secondary memory (712), removable storage drive (716), and a hard disk installed in hard disk drive or alternative persistent storage device (714).

Computer programs (also called computer control logic) are stored in main memory (710) and/or secondary memory (712). Computer programs may also be received via a communication interface (724). Such computer programs, when run, enable the computer system to perform the features of the present invention as discussed herein. In particular, the computer programs, when run, enable the processor (702) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### ALTERNATIVE EMBODIMENT

It will be appreciated that, although specific embodiments of the invention have been described herein for purposes of illustration, various modifications may be made without departing from the spirit and scope of the invention. Specifically, there are different forms of electronic communications that may be employed, including but not limited to, short message service (SMS), text based communications, electronic mail communications, etc. Accordingly, the scope of protection of this invention is limited only by the following claims and their equivalents.

We claim:

1. A method comprising:
saving new content to an electronic collaborative environment;
assessing the new content with respect to prior content saved to the collaborative environment;
based upon comparison of the new content with the prior content exceeding a threshold, automatically proposing a meeting, with both a subject of the meeting and list of attendee email addresses directly related to the new content;
pre-filling an electronic meeting invitation for the meeting, including details for the electronic meeting invitation based on the subject of the meeting and the list of attendee email addresses; and
sending the electronic meeting invitation for the meeting to each of the attendees.

2. The method of claim 1, further comprising evaluating the type of data saved to the collaborative environment, and based on the evaluated data type selectively scheduling the meeting.

3. The method of claim 1, further comprising from the comparison identifying content changes and classifying a level of changes based on an associated quantity of identified content changes.

4. The method of claim 3, further comprising the quantity of content changes assessed as minor, and limiting the attendees to a select set of collaborators and limiting a duration for the meeting.

5. The method of claim 3, further comprising the quantity of content changes assessed as moderate, and extending the attendees to a moderate class of collaborators, larger than a select set of collaborators, and setting a duration for the meeting to a moderate class, the duration larger than a limited duration associated with an assessment of minor content changes.

6. The method of claim 3, further comprising the quantity of content changes assessed as major, and extending the attendees to all collaborators, and setting the duration for the meeting to a maximum amount of time.

7. A computer system comprising:
a computing node with a processor to support meeting scheduling in a virtual collaborative environment in response to receipt of new content;
an assessment manager to evaluate the new content with respect to prior content saved to the collaborative environment;
a comparison manager to compare the new content with the prior content, and based upon whether the comparison exceeds a threshold, the comparison manager to automatically propose a meeting, with both a subject of a meeting and list of attendee email addresses directly related to the new content;
an invitation manager to pre-fill an electronic meeting invitation for the meeting with details for the electronic meeting invitation based on the subject of the meeting and the list of attendee email addresses; and
the invitation manager to send an electronic meeting invitation for the meeting to each of the attendees.

8. The computer system of claim 7, further comprising an evaluation manager to evaluate the type of data saved to the collaborative environment, and to selectively schedule the meeting based on the evaluated data type.

9. The computer system of claim 7, further comprising the comparison manager to use the comparison to identify content changes, and to classify a level of changes based on an associated quantity of content changes.

10. The computer system of claim 9, further comprising the assessment manager to assess the quantity of content changes as minor, to limit the attendees to a select set of collaborators, and to limit duration for the meeting.

11. The computer system of claim 9, further comprising the assessment manager to assess the quantity of content changes as moderate, to extend the attendees to a moderate class of collaborators, larger than a select set of collaborators, and to set a duration for the meeting to a moderate class, the duration larger than a limited duration associated with an assessment of minor content changes.

12. The computer system of claim 9, further comprising the assessment manager to assess the quantity of content changes as major, to extend the attendees to all collaborators, and to set the duration for the meeting to a maximum amount of time.

13. A computer program product delivered as a service through a network connection, the computer program product comprising a computer readable storage device in communication with a processing unit, the storage device having computer readable program code embodied therewith, the computer readable program code comprising:
computer readable program code to save new content to an electronic collaborative environment;
computer readable program code to evaluate the new content with respect to prior content saved to the collaborative environment;
based upon whether a comparison of the new content with the prior content exceeds a threshold, computer readable program code to automatically propose a meeting, with both a subject of the meeting and list of attendee email addresses directly related to the new content;
computer readable program code to pre-fill an electronic meeting invitation for the meeting, including details for the electronic meeting invitation based on the subject of the meeting and the list of attendee email addresses; and
computer readable program code to send the electronic meeting invitation for the meeting to each of the attendees.

14. The computer program product of claim 13, further comprising computer readable program code to evaluate the type of data saved to the collaborative environment, and to selectively schedule the meeting based on the evaluated data type.

15. The computer program product of claim 13, further comprising computer readable program code to identify content changes from the comparison, and to classify a level of changes based on an associated quantity of content changes.

16. The computer program product of claim 15, further comprising computer readable program code to assess the quantity of content changes as minor, to limit the attendees to a select set of collaborators, and to limit a duration for the meeting.

17. The computer program product of claim 15, further comprising computer readable program code to assess the quantity of content changes as moderate, to extend the attendees to a moderate class of collaborators, larger than a select set of collaborators, and to set a duration for the meeting to a moderate class, the duration larger than a limited duration associated with an assessment of minor content changes.

18. The computer program product of claim 15, further comprising computer readable program code to assess the quantity of content changes as major, to extend the attendees to all collaborators, and to set the duration for the meeting to a maximum amount of time.
